(19) United States
(12) Patent Application Publication
(10) Pub. No.: US 2016/0209816 A1
(43) Pub. Date: Jul. 21, 2016

(54) CASCADED ACTIVE DISTURBANCE REJECTION CONTROLLERS

(71) Applicant: LINESTREAM TECHNOLOGIES, Cleveland, OH (US)

(72) Inventor: David Neundorfer, Cleveland, OH (US)

(21) Appl. No.: 15/002,669

(22) Filed: Jan. 21, 2016

Related U.S. Application Data
(60) Provisional application No. 62/105,785, filed on Jan. 21, 2015.

(51) Int. Cl. G05B 13/02

(52) U.S. Cl. CPC G05B 13/024

(57) ABSTRACT

Cascaded active disturbance rejection control (ADRC) controllers are used in place of proportional-integral-derivative (PID) controllers for control of multiple plants comprising a facility, thereby achieving high stabilization across the facility. This configuration substantially damps cross-talk between systems, and yields consistent control of perturbations to the plants. Cascaded ADRC controllers can yield less waste, greater efficiency, less wear and tear on physical equipment, a higher quality product, and/or improved time efficiency. PID controllers can be retrofitted with ADRC controllers in two or more related plants. Alternatively, ADRC controllers can be designed for implementation in newly instantiated facilities comprising at least two related plants where ADRC is selected at the outset for process control.

### CROSS-REFERENCE TO RELATED APPLICATIONS

This application claims the benefit of U.S. Provisional Patent Application Ser. No. 62/105,785, filed on Jan. 21, 2015, and entitled “CASCADED ACTIVE DISTURBANCE REJECTION CONTROLLERS,” the entirety of which is incorporated herein by reference.

### TECHNICAL FIELD

This disclosure generally relates to process control, and, for example, to the use of cascaded active disturbance rejection control (ADRC) controllers in place of proportional-integral-derivative (PID) controllers to control multiple plants and to achieve high stabilization across a facility.

### BACKGROUND

A plant in control theory is a combination of a process and an actuator. A facility consists of multiple plants. A facility may be a physical place, like a factory. As a collection of plants (as that term is understood in control theory), a facility may also comprise controlled components such as a motors or engines. There are many different types of plants recognized in control theory. Some plants may be related, while others are different from one another. Examples of related plants may include a series of heating baths or ovens which attempt to regulate the temperature of materials that are passing through the baths or ovens in a series or parallel progression. Examples of unrelated plants may include a controlled robot arm in a first part of a production line and a controlled conveyor belt in a second, unlinked part of a production line.

Control of a plant is often carried out by a control-loop feedback mechanism. A control-loop feedback mechanism computes an error value as the difference between a measured variable and a desired set point. For example, a heating bath may seek to maintain a 70 degree Celsius set point, but the introduction of a material at a different temperature, perhaps hotter or perhaps cooler, causes the bath to deviate from that set point. A feedback controller can compute this deviation and control the heating (or cooling) of the bath in an effort to return the temperature to the set point. If such adjustments are made too quickly, there is a possibility of overshooting the set point, resulting in system instability. If adjustments are made too slowly, there is a possibility of significant lag, resulting in lower quality. Other positive and negative impacts are possible with non-optimized feedback control.

The above-described is merely intended to provide an overview of some of the challenges facing conventional plant control systems. Other challenges with conventional systems and contrasting benefits of the various non-limiting embodiments described herein may become further apparent upon review of the following description.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its purpose is to present some concepts of one or more embodiments in a simplified form as a prelude to the more detailed description that is presented later.

One or more embodiments of this disclosure are directed, though not limited, to process control in the context of related plants to achieve superior results in a facility. In one or more embodiments, multiple controllers that support active disturbance rejection control (ADRC) are used to control respective multiple related plants in a facility to yield a high level of stabilization across the entire facility. The use of cascaded ADRC controllers can damp cross-talk between systems, and can cause the overall system comprising the multiple plants to produce less waste and achieve higher efficiency relative to PID control or other types of control.

The following description and the annexed drawings set forth herein detail certain illustrative aspects of the one or more embodiments. These aspects are indicative, however, of but a few of the various ways in which the principles of various embodiments can be employed, and the described embodiments are intended to include all such aspects and their equivalents.

### BRIEF DESCRIPTION OF THE DRAWINGS

FIG. 1 is a block diagram of a single PID controller.

FIG. 2 is a block diagram of a single ADRC controller.

FIG. 3 is a block diagram of an example facility that employs multiple, cascaded ADRC controllers.

FIG. 4 is a chart comparing the performance of multiple PID controllers versus multiple ADRC controllers in the context of a particular facility for the parameter of temperature variance from a set point.

FIG. 5 is a chart comparing the performance of multiple PID controllers versus multiple ADRC controllers in the context of a particular facility for the parameter of duty cycle of temperature control.

FIG. 6 is a flow chart of an example methodology for controlling a set of related plants.

FIG. 7 is a block diagram representing an exemplary networked or distributed computing environment for implementing one or more embodiments described herein.

FIG. 8 is a block diagram representing an exemplary computing system or operating environment for implementing one or more embodiments described herein.

### DETAILED DESCRIPTION

Various embodiments are now described with reference to the drawings, wherein like reference numerals refer to like elements throughout. In the following description, for the purposes of explanation, numerous specific details are set forth in order to provide an understanding of this disclosure. It is to be understood, however, that such embodiments may be practiced without these specific details, or with other methods, components, materials, etc. In other instances, structures and devices are shown in block diagram form to facilitate describing one or more embodiments.

A frequently employed method for feedback control in industrial automation is proportional-integral-derivative (PID) control. A PID controller uses three parameters as part of its tuning algorithm—the proportional (P), the integral (I), and the derivative (D) values. The P value is related to the current error in the system. The I value (as an integral or accumulation of past errors) is related to past error. The D value (as the derivative of rate of change of error) is related to future error. Significant time and energy are spent by control engineers to tune these parameters across operating conditions, both algorithmically and manually, in real-world instances of controlling plants and facilities.

As an alternative method for feedback control, active disturbance rejection control (ADRC) differs from PID control by introducing an extended state observer (ESO). The ESO is incorporated in the control feedback loop and performs online estimates of internal and external disturbances (e.g., unknown internal dynamics as well as external disturbances), allowing the controller to compensate for total disturbance on the plant. This configuration effectively decouples the plant from the disturbances acting upon the plant. In an example ADRC control system, an ADRC controller is parameterized such that the controller parameters are functions of a single tuning variable—such as the controller bandwidth—while achieving process control results similar to, if not exceeding, a comparable PID controller across operating conditions. Since tuning the ADRC system is a matter of tuning a single tuning parameter (e.g., the controller bandwidth), a benefit of ADRC is that tuning is often simplified versus a comparable PID controller. In some embodiments of ADRC, the ESO can also be tuned using the observer bandwidth as the sole tuning parameter.

In collections of plants that make up facilities, including plants that carry out related steps, multiple PID controllers can be used. However, the process of tuning and retuning PID control loops can be substantial and time consuming, especially in cases of multiple plants forming facilities.

To address these and other issues, one or more embodiments of the present disclosure relate to the use of ADRC with two or more related plants in a facility to yield an unanticipated benefit of higher stabilization across the entire facility. Use of cascaded ADRC controllers can damp cross-talk between systems and result in consistent control of perturbations to the plants. These benefits can result in less waste, greater energy efficiency, less wear and tear on physical equipment, a higher quality product, and/or improved time efficiency. In some scenarios, PID controllers can be retrofitted with ADRC in two or more related plants. In other scenarios, cascaded ADRC controllers can be implemented in newly instantiated facilities comprising at least two related plants where ADRC is selected at the outset for process control.

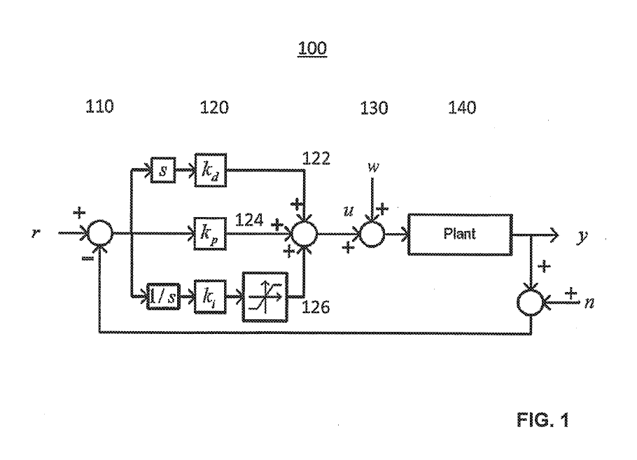

FIG. 1 is a block diagram of a single PID controller. PID controller 100 comprises four stages. First stage 110 comprises a closed-loop control feedback stage that includes the input of an error calculation. The error calculation, for example, is the difference between an actual value of a controlled parameter and a set point value of the parameter. For example, in the case of a temperature control plant, the parameter may be a temperature. Second stage 120 generates the control signal (u) using the PID method. As previously discussed and as shown in FIG. 1, there are three components to a PID control calculation. One element is the proportional calculation 124, which reflects the current error rate (kₚ). A second element is the integral calculation 126, which reflects the accumulated error from the past (kₗ). A third element is the derivative calculation 122, which reflects the rate-of-change of the error, or the projected error rate in the future (k_{d}). Third stage 130 provides the control signal to plant 140. Plant 140 may be any sort of plant as understood in control theory (e.g., an oven).

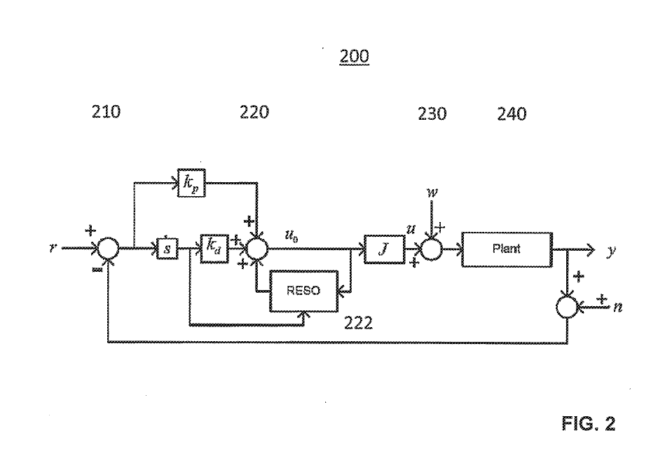

FIG. 2 is a block diagram depicting a single ADRC controller. ADRC controller 200 also comprises four stages. First stage 210 comprises a closed-loop control feedback stage that includes the input of an error calculation. The error calculation, for example, is the difference between an actual temperature and a set-point temperature if the ADRC controller is provided in the context of a temperature control plant. Second stage 220 generates the control signal (u) using an ADRC method. Second stage 120 of the PID controller 100 and second stage 220 of the ADRC controller differ. In second stage 220 of the ADRC controller, the extended state observer (ESO) 222 plays a role in the calculation of the control signal in the ADRC method, requiring fewer variables and less tuning than in a method using PID control. Similar to the PID method, third stage 230 provides the control signal to plant 240. Plant 240 may be any sort of plant as understood in control theory (e.g., an oven). It should be noted that the overall block diagrams for PID controller 100 and ADRC controller 200 share common inputs and outputs, so can be readily substituted for each other.

ADRC controller 200 can be any type of ADRC controller. Examples of ADRC control methods include, but are not limited to, the disclosures in the following patents. U.S. Pat. No. 8,041,436 teaches techniques for linear ADRC. U.S. Pat. No. 8,060,340 teaches techniques for ADRC and various extended state observers. U.S. Pat. Nos. 8,180,464 and 8,644,963 teach additional techniques for extended state observation in the context of an ADRC controller. U.S. Pat. No. 8,571,691 teaches a graphical user interface for implementing ADRC control. U.S. Pat. No. 8,710,777 teaches methods for automatic inertial estimation for use in ADRC control. These six disclosures and other relevant teachings of ADRC control are included by reference in this disclosure as if fully set forth in this document.

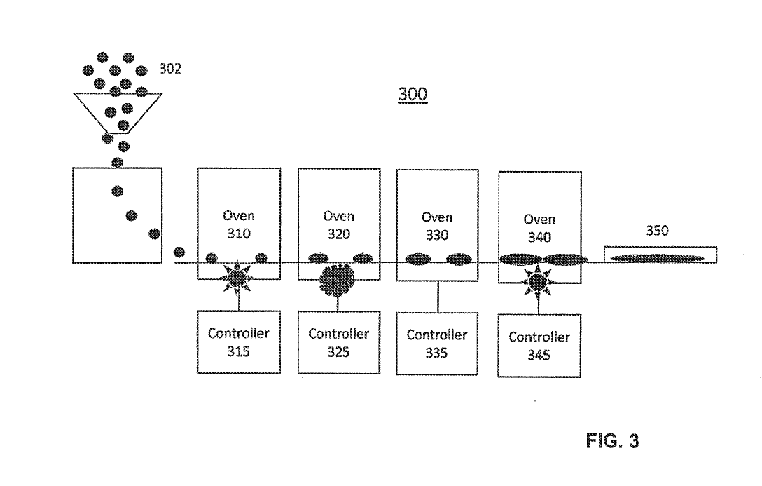

FIG. 3 is a block diagram of an example facility 300 that employs multiple, cascaded controllers. The example depicted in FIG. 3 illustrates a step in the manufacture of thermoplastic hose tubing comprising the melting of solid plastic raw material pellets 302 to make liquefied plastic suitable for extrusion at an optimal temperature set point 350. In a facility of scale, there are often multiple temperature control stages rather than a single temperature control zone in the process for liquefying material. FIG. 3 illustrates the use of four temperature control zones, including ovens 310, 320, 330 and 340. Each oven has a separate controller in communication with its related oven, including controllers 315, 325, 335, and 345. As used herein, communication generally means electrical communication through one or more electrical circuits. In the example shown in FIG. 3, the temperature control zones are able to heat as shown with ovens 310 and 340 as well as to cool as shown with oven 320. A cooling element may be a fan or other type of cooling mechanism.

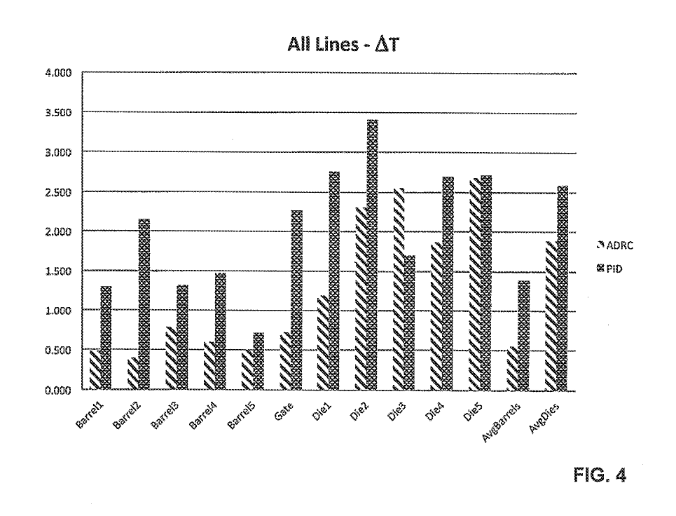

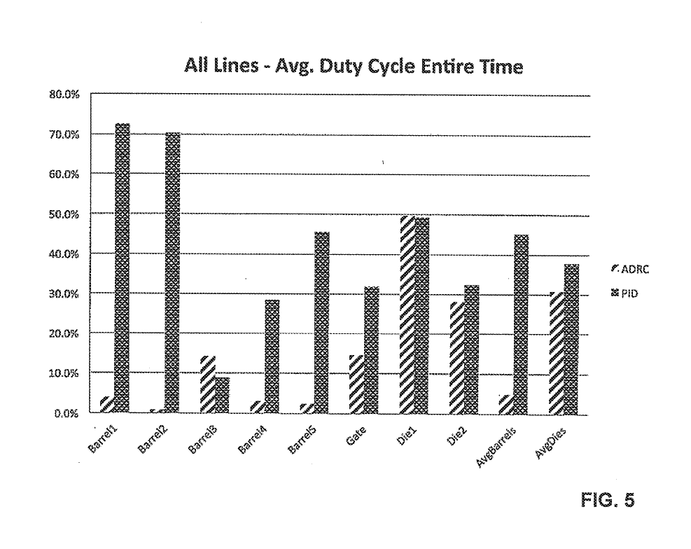

Controllers 315, 325, 335 and 345 may employ different forms of closed-loop control. In many plants, controllers in FIG. 3 comprise PID controllers as shown in FIG. 1. It is possible, however, to retrofit facility 300 to use ADRC controllers as shown in FIG. 2. As discussed below with regard to FIGS. 4 and 5, unanticipated benefits have been found when ADRC controllers are used across controllers 315, 325, 335 and 345 rather than PID controllers. It is also possible to design a new facility to incorporate ADRC controllers and achieve the same benefits.

In the example shown in FIG. 3, there is no supervisory controller, which is a master controller that is in communication with each of controllers 315, 325, 335, and 345 and provides a supervisory function between the various controllers. It is possible to implement this disclosure in facilities that include one or more supervisory controllers, or that do not make use of supervisory control. In certain facilities, supervisory control may be altogether eliminated based on the enhanced performance provided by ADRC control versus PID control at the individual control-loop feedback stages of individual plants.

In an example test implementation, five stages of oven were used (rather than four as shown in FIG. 3), and eleven adjacent zones for melting material and extruding material to produce pipe comprised the facility. All were updated with ADRC controllers in place of existing PID controllers. It was found that the cross-talk between control systems was damped and there was more consistent control of material flow and temperature. This results in less waste, greater energy efficiency, less wear and tear on the facility, a higher quality product, and/or good time efficiency. In this example, the facility was able to eliminate the use of fans altogether (which had been necessary to address temperature overshoot when PID control was used for temperature regulation).

FIG. 4 is a chart comparing the performance of multiple PID controllers versus multiple ADRC controllers in the context of a particular facility for the parameter of temperature variance from a set point. The plants comprising the facility are shown along the x-axis, and the temperature variances from a set point measured in degrees Celsius are shown along the y-axis. In most instances, the use of ADRC controllers in place of PID controllers shows substantial improvement when measuring temperature deviation from a set point. In particular, within the five “barrels” comprising the heating elements, temperature variance from set point is on the order of 0.5 degree Celsius from the desired temperature for the ADRC controllers versus nearly 1.5 degrees Celsius for the PID controllers. This approximately 3× improvement in control yields a better process with a number of benefits including less waste, a higher quality product, and/or improved time efficiency.

FIG. 5 is a chart comparing the performance of multiple PID controllers versus multiple ADRC controllers in the context of a particular facility for the parameter of duty cycle of temperature control. The plants comprising the facility are shown along the x-axis, and the duty cycle for temperature control as a percent “on” are shown along the y-axis. In most instances, the use of ADRC controllers in place of PID controllers shows substantial improvement when measuring duty cycle. In particular, within the five “barrels” comprising the heating elements, the duty cycle is approximately 5% for the ADRC controllers versus nearly 45% for the PID controllers. This 9× improvement is nearly an order of magnitude, which is reflected in lower energy consumption, and less wear and tear on physical equipment, among other potential benefits. In the example, testing shows that the system with ADRC controllers uses approximately 57% less energy than the system with PID controllers, when one fixes the rate of output from the facility to be equivalent.

In the illustrated example, control blocks 315, 325, 335 and 345 are organized in series. That is, the ovens controlled by the respective controllers are arranged to carry out processes in series, whereby materials progress through each of the ovens in a sequential fashion. However, the same benefits may be available in related plants that carry out parallel processes as well. It should be understood for purposes of this disclosure that cascaded means multiple stages of control of a facility where the plants comprising the facility are related, as previously discussed. The cascade relationship may include a physical configuration that is in series (such as shown in FIG. 3), a physical configuration that is in parallel, or a mix of the series and parallel modes. An example of a physical configuration in parallel is the use of multiple extrusion lines next to each other where physical proximity of the lines impacts the temperature among and between the lines. An example of a mixed configuration is the use of two parallel extrusion lines next to each other where each line itself employs four ovens in series (for a total of eight ovens). It is possible to use any number of cascaded controllers, provided there are at least two.

In the example illustrated in FIG. 3, the facility is one for melting material and extruding material to produce pipe. It should be understood for purposes of this disclosure that other kinds of plants, such as polymer, pharmaceutical, food and beverage production facilities, power plants, oil refineries or other refineries, natural gas processing and biochemical plants, water and wastewater treatment, pollution control equipment, chemical or other reactor systems, and other types of plants are pertinent to the disclosure, and may also benefit from the implementation of cascaded ADRC controllers. There are also a number of physical systems comprising facilities where the invention in this disclosure is pertinent. Examples of such physical systems include, without limitation, robots, manned and unmanned vehicles of any sort, motors and related systems, heating ventilation and cooling systems, appliances and other electromechanical systems. Other uses of the proposed invention will be understood by those of ordinary skill in the art.

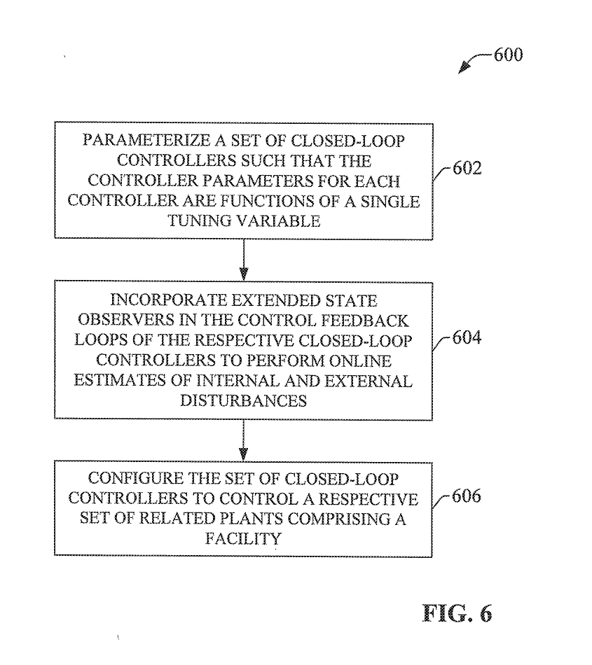

FIG. 6 illustrates a methodology in accordance with certain disclosed aspects. While, for purposes of simplicity of explanation, the methodology is shown and described as a series of acts, it is to be understood and appreciated that the disclosed aspects are not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with certain disclosed aspects. Additionally, it is to be further appreciated that the methodologies disclosed hereinafter and throughout this disclosure are capable of being stored on an article of manufacture to facilitate transporting and transferring such methodologies to computers.

FIG. 6 illustrates an example methodology 600 for controlling a set of related plants. Initially, at 602, a set of closed-loop controllers are parameterized such that the controller parameters for each controller are functions of a single tuning variable. In one or more embodiments, this single tuning parameter can be the controller bandwidth of each controller. At 604, an extended state observer is incorporated in the control feedback loops of the respective closed-loop controllers to perform online estimates of internal and external disturbances. At 606, the set of closed-loop controllers are configured to control a respective set of plants comprising a facility. The plants may be configured to execute serial processes (as in the example depicted in FIG. 3), parallel processes, or a combination of parallel and serial processes.

### Exemplary Networked and Distributed Environments

One of ordinary skill in the art can appreciate that the various embodiments described herein can be implemented in connection with any computer or other client or server device, which can be deployed as part of a computer network or in a distributed computing environment, and can be connected to any kind of data store where media may be found. In this regard, the various embodiments of the controllers and plants described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the various embodiments of this disclosure.

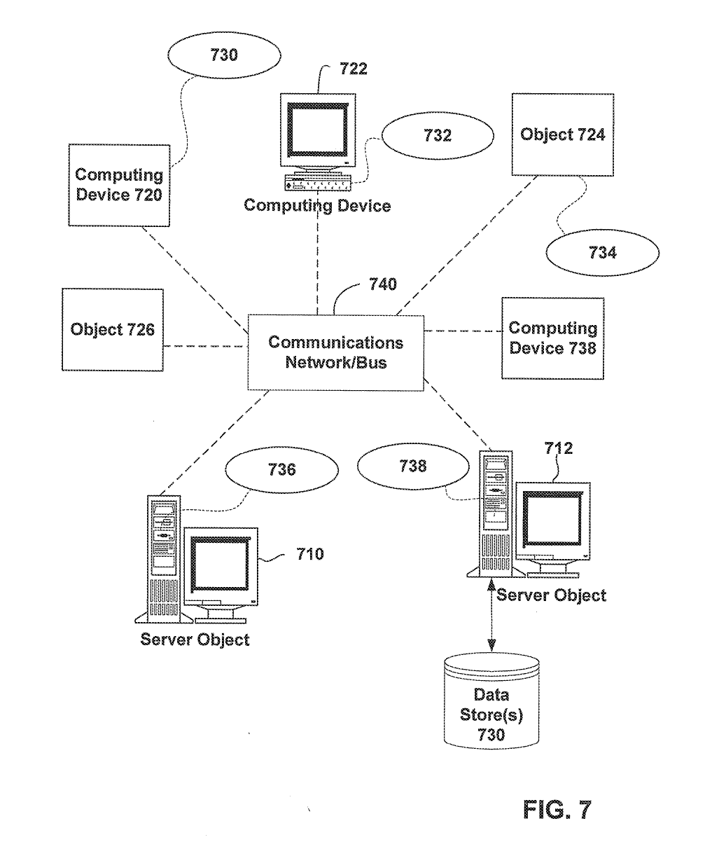

FIG. 7 provides a schematic diagram of an exemplary networked or distributed computing environment. The distributed computing environment includes computing objects 710, 712, etc. and computing objects or devices 720, 722, 724, 726, 728, etc., which may include programs, methods, data stores, programmable logic, etc., as represented by applications 730, 732, 734, 736, 738. It can be appreciated that computing objects 710, 712, etc. and computing objects or devices 720, 722, 724, 726, 728, etc. may comprise different devices, such as personal digital assistants (PDAs), audio/video devices, mobile phones, digital music players, personal computers, laptops, tablets, etc., where embodiments of the inertia estimator described herein may reside on or interact with such devices.

Each computing object 710, 712, etc. and computing objects or devices 720, 722, 724, 726, 728, etc. can communicate with one or more other computing objects 710, 712, etc. and computing objects or devices 720, 722, 724, 726, 728, etc. by way of the communications network 740, either directly or indirectly. Even though illustrated as a single element in FIG. 7, communications network 740 may comprise other computing objects and computing devices that provide services to the system of FIG. 7, and/or may represent multiple interconnected networks, which are not shown. Each computing object 710, 712, etc. or computing objects or devices 720, 722, 724, 726, 728, etc. can also contain an application, such as applications 730, 732, 734, 736, 738, that might make use of an API, or other object, software, firmware and/or hardware, suitable for communication with or implementation of various embodiments of this disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any suitable network infrastructure can be used for exemplary communications made incident to the systems as described in various embodiments herein.

Thus, a host of network topologies and network infrastructures, such as client/server, peer-to-peer, or hybrid architectures, can be utilized. The “client” is a member of a class or group that uses the services of another class or group. A client can be a computer process, e.g., roughly a set of instructions or tasks, that requests a service provided by another program or process. A client process may utilize the requested service without having to “know” all working details about the other program or the service itself.

In a client/server architecture, particularly a networked system, a client can be a computer that accesses shared network resources provided by another computer, e.g., a server. In the illustration of FIG. 7, as a non-limiting example, computing objects or devices 720, 722, 724, 726, 728, etc. can be thought of as clients and computing objects 710, 712, etc. can be thought of as servers where computing objects 710, 712, etc. provide data services, such as receiving data from client computing objects or devices 720, 722, 724, 726, 728, etc., storing of data, processing of data, transmitting data to client computing objects or devices 720, 722, 724, 726, 728, etc., although any computer can be considered a client, a server, or both, depending on the circumstances. Any of these computing devices may be processing data, or requesting transaction services or tasks that may implicate the techniques for systems as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 740 is the Internet, for example, the computing objects 710, 712, etc. can be Web servers, file servers, media servers, etc. with which the client computing objects or devices 720, 722, 724, 726, 728, etc. communicate via any of a number of known protocols, such as the hypertext transfer protocol (HTTP). Computing objects 710, 712, etc. may also serve as client computing objects or devices 720, 722, 724, 726, 728, etc., as may be characteristic of a distributed computing environment.

### Exemplary Computing Device

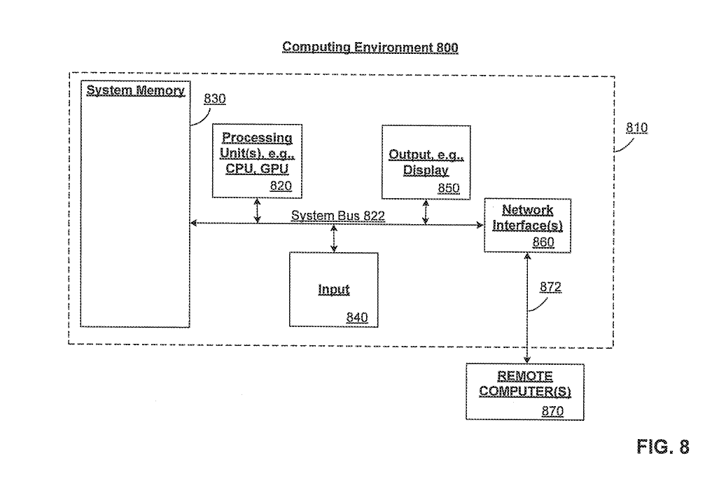

As mentioned, advantageously, the techniques described herein can be applied to any suitable device. It is to be understood, therefore, that handheld, portable and other computing devices and computing objects of all kinds are contemplated for use in connection with the various embodiments. Accordingly, the below computer described below in FIG. 8 is but one example of a computing device. Additionally, a suitable server can include one or more aspects of the below computer, such as a media server or other media management server components.

Although not required, embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 8 thus illustrates an example of a suitable computing system environment 800 in which one or aspects of the embodiments described herein can be implemented, although as made clear above, the computing system environment 800 is only one example of a suitable computing environment and is not intended to suggest any limitation as to scope of use or functionality. Neither is the computing system environment 800 be interpreted as having any dependency or requirement relating to any one or combination of components illustrated in the exemplary computing system environment 800.

With reference to FIG. 8, an exemplary computing device for implementing one or more embodiments in the form of a computer 810 is depicted. Components of computer 810 may include, but are not limited to, a processing unit 820, a system memory 830, and a system bus 822 that couples various system components including the system memory to the processing unit 820.

Computer 810 typically includes a variety of computer readable media and can be any available media that can be accessed by computer 810. The system memory 830 may include computer storage media in the form of volatile and/or nonvolatile memory such as read only memory (ROM) and/or random access memory (RAM). By way of example, and not limitation, system memory 830 may also include an operating system, application programs, other program modules, and program data.

A user can enter commands and information into the computer 810 through input devices 840, non-limiting examples of which can include a keyboard, keypad, a pointing device, a mouse, stylus, touchpad, touchscreen, trackball, motion detector, camera, microphone, joystick, game pad, scanner, or any other device that allows the user to interact with computer 810. A monitor or other type of display device is also connected to the system bus 822 via an interface, such as output interface 850. In addition to a monitor, computers can also include other peripheral output devices such as speakers and a printer, which may be connected through output interface 850. In one or more embodiments, input devices 840 can provide user input to user interface 850, while output interface 850 can correspond to user interface 850.

The computer 810 may operate in a networked or distributed environment using logical connections to one or more other remote computers, such as remote computer 870. The remote computer 870 may be a personal computer, a server, a router, a network PC, a peer device or other common network node, or any other remote media consumption or transmission device, and may include any or all of the elements described above relative to the computer 810. The logical connections depicted in FIG. 8 include a network 872, such local area network (LAN) or a wide area network (WAN), but may also include other networks/buses e.g., cellular networks.

As mentioned above, while exemplary embodiments have been described in connection with various computing devices and network architectures, the underlying concepts may be applied to any network system and any computing device or system in which it is desirable to publish or consume media in a flexible way.

Also, there are multiple ways to implement the same or similar functionality, e.g., an appropriate API, tool kit, driver code, operating system, control, standalone or downloadable software object, etc. which enables applications and services to take advantage of the techniques described herein. Thus, embodiments herein are contemplated from the standpoint of an API (or other software object), as well as from a software or hardware object that implements one or more aspects described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the aspects disclosed herein are not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function (e.g., coding and/or decoding); software stored on a computer readable medium; or a combination thereof.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In order to provide for or aid in the numerous inferences described herein, components described herein can examine the entirety or a subset of the data to which it is granted access and can provide for reasoning about or infer states of the system, environment, etc. from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines, etc.) can be employed in connection with performing automatic and/or inferred action in connection with the claimed subject matter.

A classifier can map an input attribute vector, x=(x1, x2, x3, x4, xn), to a confidence that the input belongs to a class, as by f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

In view of the exemplary systems described above, methodologies that may be implemented in accordance with the described subject matter will be better appreciated with reference to the flowcharts of the various figures (e.g., FIG. 6). While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be effected across a plurality of devices. Accordingly, the invention is not to be limited to any single embodiment, but rather can be construed in breadth, spirit and scope in accordance with the appended claims.

What is claimed is:

1. A system to control a facility, comprising:
a plurality of controllers configured to control a respective plurality of related plants comprising a facility,
the plurality of controllers respectively employing closed-loop control feedback and at least two of the plurality of controllers using active disturbance rejection control.

2. The system of claim 1, wherein the at least two of the plurality of controllers are tuned using a single tuning parameter.

3. The system of claim 2, wherein the single tuning parameter is a controller bandwidth of the respective at least two of the plurality of controllers.

4. The system of claim 2, wherein the at least two of the plurality of controllers include extended state observers (ESOs) incorporated in respective control feedback loops of the at least two of the plurality of controllers.

5. The system of claim 4, wherein the ESOs are tuned using, as a single tuning parameter, respective observer bandwidths of the ESOs.

6. The system of claim 1, wherein the plurality of related plants comprise at least one of heating baths; ovens; industrial robots, heating, ventilation, and cooling (HVAC) systems; industrial appliances, or motors.

7. The system of claim 1, wherein the facility comprises at least one of an extruding facility, a pharmaceutical facility, a food and beverage production facility, a power plant, an oil refinery, a natural gas processing facility, a biochemical facility, a wastewater treatment facility, a pollution control facility, or a reactor system.

8. The system of claim 1, wherein the plurality of related plants execute series processes.

9. The system of claim 1, wherein the plurality of related plants execute parallel processes.

10. A method for controlling a facility, comprising:
tuning a plurality of closed-loop controllers via adjustment of a single control loop tuning parameter for each of the closed-loop controllers in accordance with active disturbance rejection control; and
configuring the plurality of closed-loop controllers to control a respective plurality of related plants comprising a facility.

11. The method of claim 10, wherein the tuning comprises tuning, as the single control loop tuning parameter, a controller bandwidth.

12. The method of claim 10, further comprising incorporating extended state observers (ESOs) in respective control feedback loops of the plurality of closed-loop controllers.

13. The method of claim 12, further comprising tuning the ESOs via adjustment of a single ESO tuning parameter.

14. The method of claim 13, wherein the tuning the ESOs comprises adjusting, as the single ESO tuning parameter, an observer bandwidth.

15. The method of claim 10, wherein the configuring comprises configuring the plurality of closed-loop controllers to control, as the plurality of related plants, at least one of a plurality of ovens; a plurality of industrial robots; a plurality of heating, ventilation, and cooling (HVAC) systems; a plurality of industrial appliances; or a plurality of motors.

16. The method of claim 10, wherein the configuring comprises configuring the plurality of closed-loop controllers to control the respective plurality of related plants comprising, as the facility, at least one of an extruding facility, a pharmaceutical facility, a food and beverage production facility, a power plant, an oil refinery, a natural gas processing facility, a biochemical facility, a wastewater treatment facility, a pollution control facility, or a reactor system.

17. The method of claim 10, wherein the configuring comprises configuring the plurality of closed-loop controllers to control at least one of parallel plants, parallel plants, or a combination of series and parallel plants.

18. A system, comprising:
a plurality of related plants comprising a facility; and
a plurality of controllers configured to perform closed-loop control of the plurality of related plants,
two or more of the plurality of controllers performing the closed-loop control using active disturbance rejection control.

19. The system of claim 18, wherein the two or more of the plurality of controllers are configured to perform online estimates of internal and external disturbances using extended state observers incorporated in control feedback loops of the two or more of the plurality of controllers.

20. The system of claim 18, wherein the two or more of the plurality of controllers are configured to be tuned via adjustment of a single tuning parameter.
